(19) United States
(12) Patent Application Publication
(10) Pub. No.: US 2007/0279453 A1
(43) Pub. Date: Dec. 6, 2007

(54) Method Of Bonding A Nozzle Plate To An Inkjet Printhead

(76) Inventor: Martin De Kegelaer, Waasmunster (BE)

Correspondence Address: AGFA CORPORATION;PATENT DEPARTMENT, 200 BALLARDVALE STREET, WILMINGTON, MA, 01887, US

(21) Appl. No.: 11/791,203

(22) PCT Filed: Sep. 27, 2005
(86) PCT No.: PCT/EP05/54820

§ 371 Date: Jun. 14, 2007

Related U.S. Application Data
(60) Provisional application No. 60/636,790, filed on Dec. 16, 2004.

(30) Foreign Application Priority Data
Nov. 19, 2004 (EP) 04105912.2

(51) Int. Cl. B41J 2/16; B41J 2/165; B44C 1/165

(52) U.S. Cl. 347/33; 156/230; 347/47

(57) ABSTRACT

A nozzle plate is affixed to an inkjet printhead body by application of a first adhesive bonding step that hydraulically seals the ink chambers to the nozzle plate, followed by a second adhesive bonding step that strengthens the junction between the printhead body and the nozzle plate. The second adhesive bond may be created by capillary propagation of the second adhesive along the junction. The nozzle plate affixing method enhances the mechanical resistance of nozzle plates against peeling from the printhead body by the influence of wiper blades onto the nozzle plate during wiping.

### FIELD OF THE INVENTION

The present invention relates to a method for manufacturing inkjet printheads. More specifically the invention is related to a method for affixing a nozzle plate of an inkjet printhead to the printhead body.

### BACKGROUND OF THE INVENTION

Inkjet is a printing technology whereby ink drops are ejected from an inkjet printhead and arrive at a printing medium opposing the inkjet printhead. The ink drops are ejected from the printhead through a nozzle located in a wall of an ink ejection chamber. The driving force to expel the ink drops from the ink ejection chamber may be a piezoelectric transducer creating pressure waves in the ink chamber, as in piezo inkjet technology, or may be a heating device creating a local explosion of the ink in the ink chamber, as in thermal inkjet technology, or may be generated from other sources.

Inkjet printheads generally have multiple ink ejection chambers in communication with corresponding nozzles. The number of nozzles per printhead may range from tens to hundreds of nozzles. A general prior art example is shown in FIG. 1, taken from U.S. Pat. No. 5,976,303. A piezoelectric ceramic inkjet actuator 2 comprises ink ejection channels 3. The ink ejection channels are manufactured as open grooves in the piezoelectric ceramic and sealed at the top by a cover plate 8, leaving them open at the front end where the nozzle plate 4 will be attached, and at the back where the ink supply opening 7 provides an ink flow into the ink ejection chambers 3. The nozzle plate 4 is bonded to the front surface of the printhead body, being the assembly of the inkjet actuator 2 and the cover plate 8. In the prior art example the nozzle plate 4 is made of polyimide, but another frequently used material would be stainless steel. The nozzle plate 4 is attached to the printhead body via epoxy resin and cured through a heating process.

In the process of ejecting a drop through a nozzle, the properties of the meniscus in the nozzle are of critical importance to ejecting a reproducible volume of ink, in a reproducible direction, with a reproducible velocity, etc. Therefore the nozzles are maintained frequently to reinstall standard and reproducible meniscus conditions at the start of every drop ejection process. State of the art techniques for maintenance of nozzles and nozzle plates include purging operations (pressure purge or vacuum purge) to refresh the ink in the interior of the nozzle thereby creating the required standard ink conditions in the meniscus. This step is especially useful when using volatile inks because their physico-chemical properties change when residing too long in a non-jetting nozzle, e.g. the viscosity increases with time due to evaporation of volatile organic compounds (VOC's). Another maintenance technique involves wiping of the nozzle plate with a wiper blade in order to remove dust or excess ink around the nozzle and at the nozzle rim thereby creating reproducible meniscus positions. Both maintenance operations put stress (peel forces) on the bond between the nozzle plate and the printhead body. These peel forces may lead to delamination of the nozzle plate from the printhead body.

EP 0 566 249 describes nozzle plate bonding in a thermal inkjet cartridge assembly process. A first step bonds a nozzle plate to an actuator to form a TAB (Tape Automated Bonding) printhead assembly and a second step bonds the TAB printhead assembly to an ink cartridge, forming a sealed connection with the ink reservoir in the cartridge. The ink ejection chamber is formed by the interior boundaries of the nozzle plate, the actuator and the ink cartridge. The bond between the TAB printhead assembly and the ink cartridge is made guaranteed hydraulically sealing and mechanically strong by providing an amount of adhesive in excess between the nozzle plate and a raised wall of the ink cartridge, and providing a gutter to capture the overflow of adhesive when the nozzle plate is pushed onto the ink cartridge. EP 0 810 095 continues on the ideas of EP 0 566 249. The patent adds the feature of an adhesive dam to guide excess adhesive away from the ink chamber side (in the direction of the gutter) and reduces the squish at the junction of the nozzle plate with the ink chamber side of the raised wall of the ink cartridge. The squish is responsible for dimpling of the nozzle plate. FIG. 2 is taken from EP 0 810 095 and illustrates the bond 90 between the nozzle plate 18 and ink cartridge 10.

Another method of adhesively securing a nozzle plate to a front surface of an internally chambered piezoelectric ceramic body portion of an inkjet printhead is disclosed in U.S. Pat. No. 6,079,810. The bond strength is increased by the presence of a spaced plurality of bonding holes formed through the nozzle plate and aligned with a spaced plurality of bonding openings extending inwardly through the front end of the printhead body. As the orifice plate is pressed against the body, a portion of the initially applied adhesive flows into the holes and openings, providing additional shear strength to the bond interface.

In U.S. Pat. No. 6,609,778 a nozzle plate is bonded to a printhead body by means of a first adhesive layer, and to a nozzle plate support member by means of a second adhesive layer that is thicker than the first adhesive layer. The extra support with a thicker layer of adhesive increases the peel-off resistance of the nozzle plate during printhead maintenance with wiper blades. The back of the nozzle plate opposing the printhead body may be provided with grooves to accommodated excess glue when the nozzle plate is pressed against the printhead body. One of these grooves may be located at the junction between the back of the nozzle plate and the outer circumference of the front surface of the printhead body. Excess ink that flows into this groove may form fillets that further strengthen the nozzle plate bond.

### SUMMARY OF THE INVENTION

It would be advantageous to have a process for affixing a nozzle plate to a printhead body whereby functional requirements for hydraulic sealing and mechanical stress resistance are split and whereby different adhesives and applications processes can be used specifically suited to each individual functional requirement, one of the functional requirements being an improved mechanical peel-off resistance.

The above-mentioned advantages are realized by a method for affixing a nozzle plate onto a printhead body having a dedicated process step for increasing the mechanical peel-off resistance of the nozzle plate by applying an adhesive at a junction of the nozzle plate and the printhead body. The adhesive may be dispensed along the junction or applied at a limited number of locations along that junction to work itself around the junction via capillary forces.

In one embodiment of the invention a two-stage method is provided for bonding a nozzle plate onto a printhead body wherein the first stage includes positioning and attaching the nozzle plate to the printhead body to make a hydraulic seal between the nozzle plate and the ink ejection chamber, and the second stage includes increasing the mechanical properties of the nozzle plate to printhead body bond by applying an additional capillary bond at the junction between the nozzle plate and the printhead body.

Specific features for preferred embodiments of the invention are set out in the dependent claims.

Further advantages and embodiments of the present invention will become apparent from the following description and drawings.

### BRIEF DESCRIPTION OF THE DRAWINGS

FIG. 1 shows a prior art example of a piezoelectric printhead body having a plurality of ink chambers and a nozzle plate at the front end of the ink chambers.

FIG. 2 shows a prior art example of a bond between the nozzle plate and an ink chamber of a thermal inkjet printhead.

FIG. 3 shows a cross-sectional view along the length axis of an ink chamber with the front surface of the printhead body directed downwards, and the nozzle plate affixed tin front of the ink chamber.

FIG. 4 shows a cross-sectional view along the length axis of the ink chambers of two printhead bodies affixed to a single nozzle plate.

FIGS. 5A and 5B show two application methods for dispensing an adhesive at the junction between the printhead body and the nozzle plate.

FIGS. 6A through 6E show different embodiments of the junctions between the nozzle plate and the printhead body or the nozzle plate support, where a capillary bond may be applied. FIG. 6A shows gutter type junctions. FIG. 6B and FIG. 6C show the effect on the capillary bond when the gutter becomes too wide. FIG. 6D shows an undercut junction created with a beveled outer edge of front surface of the printhead body. FIG. 6E shows dedicated capillary tracks in the interface between the front surface of the printhead body and the back of the nozzle plate.

FIG. 7 shows the stretching effect on the nozzle plate when the adhesive of the capillary bond shrinks during curing or setting.

FIG. 8 illustrates test results obtained by experiments

FIG. 9 illustrates a simplified nozzle plate affixing process only relying on the application of an adhesive with capillary bonding properties.

### DETAILED DESCRIPTION OF THE INVENTION

Summarizing the prior art, methods for improving the mechanical strength of the bond of a nozzle plate to a printhead body may be designed into the nozzle plate itself, e.g. grooves to accommodate excess glue, or into the printhead body, e.g. cramps to be filled with excess glue, or both. The methods for bonding typically include applying an adhesive to the front surface of the printhead body or to the back of the nozzle plate, followed by pushing the nozzle plate against the printhead body. In the prior art methods only one adhesive is used and the dispensing step needs to apply a sufficient amount of that adhesive to assure that the bonding improvement features described above are provided with an adequate amount of adhesive when the two parts are affixed. Therefore there is always an excess of adhesive applied. Because there is only one adhesive and only one bond, the bond needs to have hydraulic sealing properties as well as mechanical stress resistance properties. A sufficiently thick adhesive layer is targeted to guarantee both and again an excess amount of adhesive is applied whereby the excess amount is squeezed away between the nozzle plate and the printhead body during affixing of the nozzle plate to the printhead body. The excess amount of adhesive potentially flows into the interior of the ink ejection chambers, even with a adhesive dam as disclosed in EP 0 810 095, and affects the geometry and volume of the ink ejection chambers in the vicinity of the nozzle, where it is most critical for proper operation of the printhead. The excess adhesive also effects the hydraulic response of piezoelectric actuation of the ink ejection chamber. Another disadvantage of the prior art methods for affixing a nozzle plate to a printhead body is that finally a single glue type is used that needs to comply with all requirements regarding mechanical stress, hydraulic sealing, chemical resistant against inkjet inks, thixotropic properties to keep the glue out of the ink ejection chambers, etc. This always leads to a non-optimal compromise.

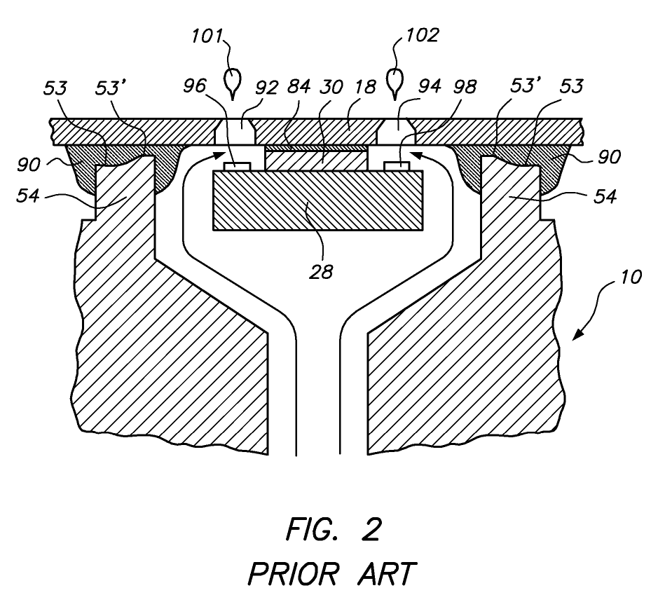

The invention will now be described in detail. In the description reference is made to a piezo inkjet printhead, although the invention is also applicable to thermal inkjet printheads. An example of a thermal inkjet printhead is described in EP 0 810 095. FIG. 2 is taken from EP 0 810 095 and illustrates the fixing of the nozzle plate 18 to the printhead cartridge 10. The method of making the bond 90 may be replaced by the method of the present invention, having a number of advantages that will become clear from the following description. In general, every inkjet printhead has an ink chamber and a nozzle plate that, in one way or another, are attached to each other. Any nozzle plate attach process will have requirements regarding hydraulic sealing of the ink chambers or ink channel, chemical resistance against the inkjet inks and a number of mechanical properties like straightness, peel-off resistance, strength, etc. The invention is applicable to all types of inkjet printheads whereby a nozzle plate is to be attached to a printhead body. The drawings used in the descriptions will illustrate the invention implemented on a piezo inkjet printhead.

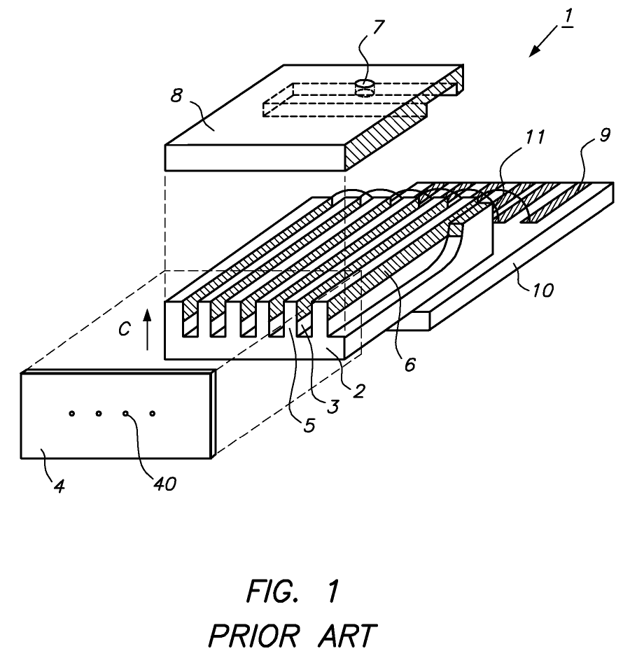

The term ‘nozzle plate’ may be any type of nozzle plate known in the art used for inkjet printheads. These include polyimide or stainless steel nozzle plates, single member nozzle plates or nozzle plate assemblies, e.g. a plurality of nozzle plates aligned and fixed to a single support plate, and may include any shape of nozzles known in the art, e.g. conical nozzles having a recess island around the exterior nozzle rim. The nozzle plate affixing process described in the present invention is largely independent of specific nozzle plate implementations. The term ‘printhead body’ covers printhead sub-assemblies comprising part or all of the ink chamber walls that together with the nozzle plate define part or all of the boundaries of the ink chambers at the nozzle end of these chambers. Examples of printhead bodies that may be used with the present invention are the assembly of piezoelectric actuator 2 with cover plate 8 in FIG. 1, or the ink cartridge 10 in FIG. 2.

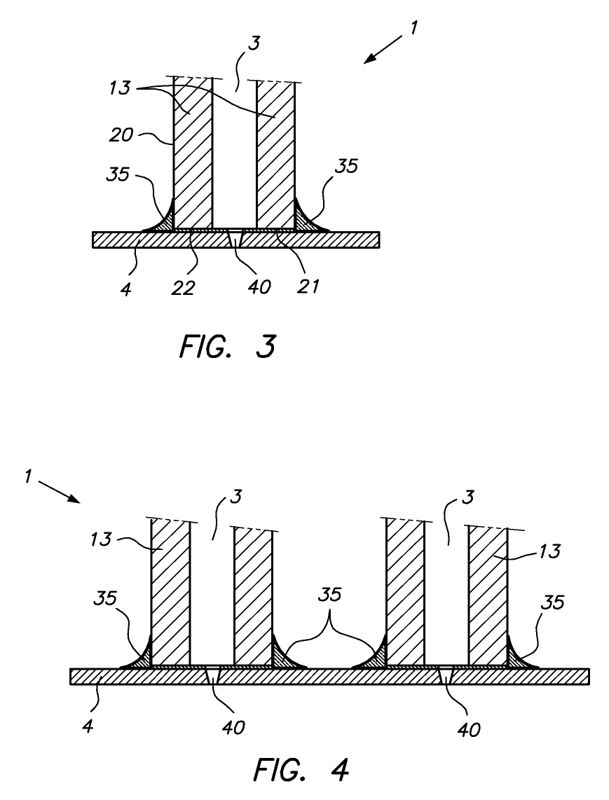

The drawings are an illustration of the principles of the present invention. The dimensions used in the drawings are not intended to provide a realistic view on the embodiments shown. Some aspects in the drawings are exaggerated in order to be able to see them and to refer to them. For example, an hydraulic bond between a nozzle plate and a front surface of a printhead body may only be a couple of micrometers whereas a capillary bond at the outer junction of both may be more than 500 micrometers, depending on the adhesive properties and the bonding process settings used. The invention will be illustrated with reference to FIG. 3, showing a simplified representation of a piezoelectric ceramic inkjet printhead 1. FIG. 3 is a cross sectional view along the length axis of an ink chamber of a printhead according to the prior art printhead depicted in FIG. 1, and perpendicular to the nozzle row in the nozzle plate. The printhead comprises a printhead body 20 having ink chambers 3 formed by top, bottom and side walls 13 and having an open end at the front surface 21 of the printhead body 20. Opposing the ink chamberfront surface 21 of the printhead body 20, a nozzle plate 4 is affixed to the printhead body 20. The process of affixing the nozzle plate 4 to the printhead body 20 comprises at least two bonding steps.

A first bonding step aims at hydraulic sealing of the printhead ink chambers 3 with the nozzle plate 4 as well as fixing the position of the nozzle plate 4 with respect to the open ends of the ink chambers 3, and may be performed using known bonding techniques for nozzle plate attach processes, if some precautionary measures are taken. These will become clear from the following discussion. The first bonding step may start with applying an adhesive layer to either the back of the nozzle plate or the front surface of the printhead bodyink chamber, via a dipping method, i.e. by dipping into an adhesive supply layer. The adhesive supply layer may be created via bar coating onto a foil. Once the printhead body or the nozzle plate has received an adhesive layer of proper thickness, both components are positioned in front of each other and advanced towards each other. Before making the adhesive contact, the nozzle plate's position with respect to the open ends of the ink chambers may be verified with optical inspection means, or mechanical datum points (references) may be used to align both parts relative to each other. A soft touch adhesive contact reduces the risk on sliding of the nozzle plate over the front surface of the printhead thereby loosing its relative position, which is a risk involved when firmly pushing the nozzle plate against the printhead body. A precise positioning of the nozzle plate relative to the printhead body and preservation of this position during the entire bonding process is an important requirement if the nozzles are pre-ablated into the nozzle plate, e.g. during an ex-situ ablation step prior to assembling the nozzle plate onto the printhead body. After affixing the nozzle plate to the printhead body, the adhesive layer 22 between both components is hardened with suitable methods depending on the type of adhesive used.

There are some risks involved with this bonding process that may be critical if this process were to be the only one to fix a nozzle plate to a printhead body. These risks relate to tolerances on the adhesive supply layer thickness on the foil during bar coating, efficiency of the dipping process in terms of transfer of adhesive from the foil to the nozzle plate, or the pressure used to affix the nozzle plate on the printhead body and the risk of excess adhesive being squeezed out and entering the ink chambers or even the nozzle opening. On the one hand, it is beneficial to limit the adhesive layer thickness and application pressure, but on the other hand, an adhesive layer being too thin may lead to voids in the adhesive bond thereby reducing mechanical strength of the bond. According to the invention the amount of adhesive applied in the first bonding step is limited and targeted only at hydraulic sealing of the ink chambers to the nozzle plate. This restriction will avoid adhesive from being squeezed away and entering the ink chambers and create a well defined hydraulic sealing as illustrated in FIG. 3, indicated with numeral 22. The lack of mechanical strength of this bond is overcome by a second bonding step different from this first hydraulic sealing step.

An adhesive being used for hydraulic sealing of an ink chamber needs to be chemically resistant or even inert with respect to the ink in the ink chambers. Also, in order to avoid the risk of adhesive flowing into the ink chamber, the adhesive may have thixotropic properties. Thixotropic properties are an advantage in the bonding process but are not a necessary condition provided that the quantity of adhesive applied and the affixing force used are well under control to avoid excess adhesive from being squeezed out and flowing into the ink chambers. Another advantageous property of the adhesive would be the ability to absorb shear stress introduced in the adhesive layer as a result of a mismatch between the coefficient of thermal expansion of the bonded materials, e.g. polyimide and piezoelectric ceramic. This property becomes more important as the thickness of the adhesive layer decreases. The inability to absorb these shear stresses may result in dimpling of the nozzle plate or even delamination of the nozzle plate. Examples of adhesives that may service the purpose of hydraulic sealing are Epotek 353ND, available from Epoxy Technology Inc., and Ablebond 931-1T1N1, available from Ablestik. Ablebond 931-1T1N1 is preferred for its thixotropic properties but is less resistant against some type of inkjet inks, e.g. water-based inks. Epotek 353ND on the other hand has good ink resistance properties but is not thixotrope and thus can easily flow into the ink chambers if the adhesive was applied too thick or if the nozzle plate was pushed too hard against the front surface of the printhead body.

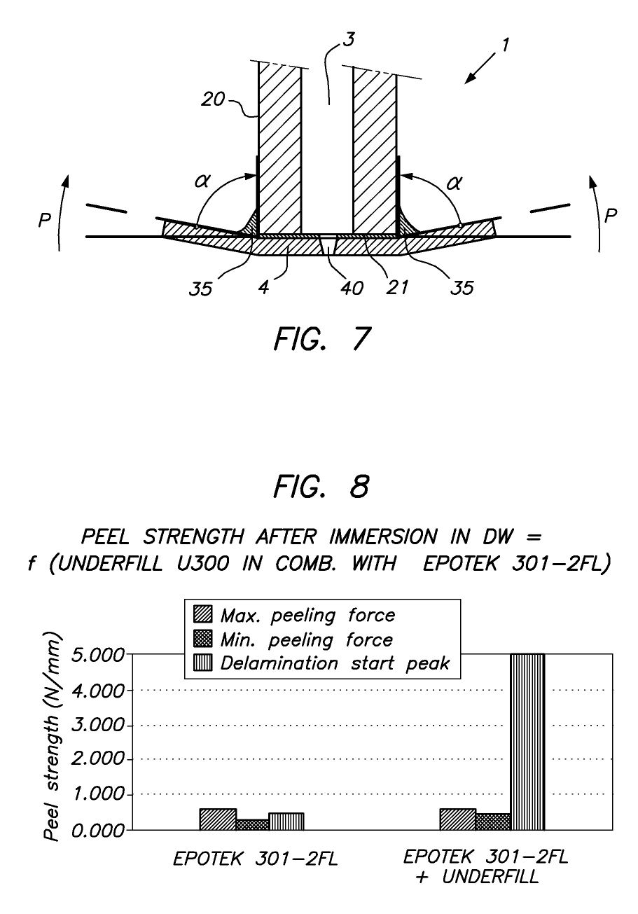

A second bonding step will further enhance the mechanical strength of the bond between the nozzle plate 4 and the printhead body 20. Because mechanical peeling always starts at the junction between two components, it is of outmost importance to strengthen this junction. In preventing peeling-off of a nozzle plate under the forces generated by a wiper blade passing over it, it is therefore important to strengthen the external junction between the back of the nozzle plate 4 and the front surface 21 of the printhead body 20, i.e. along the exterior circumference of the front end side of the ink chambers 3. In FIG. 3 the location of this bond 35 is illustrated. The bond may be applied at critical, i.e. peel sensitive, locations along the junction, or may be applied along the full length of the junction. The adhesive may be applied using state of the art dispensing techniques for dispensing an adhesive along a junction. These techniques are well known in the art and can be used with a wide range of adhesives and adhesive properties. While dispensing technologies as such are widely spread and easily accessible, there may be physical constraints in the nozzle plate bonding process prohibiting the use of these technologies because of limited access to the junction for the dispensing tool. If accessibility of the junction by a dispensing tool may pose a problem, the bonding technique may rely on capillary phenomena to guide adhesive towards inaccessible parts of the junction. The bond then preferably has a capillary meniscus because a capillary meniscus provides a very efficient bond in terms of strength versus adhesive volume, and is able to propagate along the junction line without additional external effort. Therefore this second bond will be referred to in the rest of the description as a capillary bond, in addition to the hydraulic bond or sealing discussed above. In order to create a uniform capillary bond at the junction of the nozzle plate and the printhead body, the adhesive needs to have properties similar to an underfill glue used in electronics assembly, e.g. low viscosity, being able to propagate or work itself around a junction line or into capillaries, must be sufficiently wetting with respect to the materials it comes into contact with, and have a high peel resistance and mechanical strength after curing. On the other hand adhesive properties are less critical with respect to chemical resistant to inkjet ink, because the adhesive is applied at the outside of the ink chambers. Suitable adhesives for the capillary bond are Epotek U300 and Epotek 301-2FL, both available from Epoxy Technology Inc. The Epotek U300 is a representative underfill adhesive used in the electronics industry with good mechanical peel properties, but needs to be applied at elevated temperature to have good capillary flow. If this is a problem, the Epotek 301-2FL is a good alternative with also good mechanical peel properties and with a low viscosity at room temperature and therefore more easily capillary dispensable at room temperature. Capillary properties, as for example shape of the meniscus and strength of the bond, are also depending on the junction configuration, e.g. a right angle, a chamfer or a gutter, and the material properties of the nozzle plate and printhead body. A further advantage of epoxy adhesives used for capillary bonding is that the adhesives shrink during curing or setting thereby stretching the nozzle plate and reducing the risk for dimpling of the nozzle plate, an effect similar to stretching of cloth over a frame by the effect of spring forces. FIG. 7 shows an exaggerated illustration of this effect. In FIG. 7 the shrinking of the adhesive material reduces the bond angle α from initially 90° to for example 80°, thereby bending the nozzle plate over the front edge of the printhead body, in the direction of arrow P in FIG. 7, along the entire bond line. The bending stretches the nozzle plate.

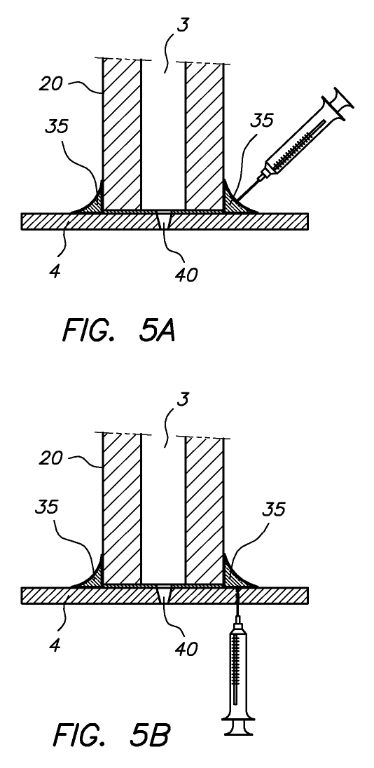

The capillary bond can be applied in different ways and at different stages in the production process of the printhead. The self-distributing property of an adhesive allows the use of only one or a limited number of application points for the adhesive. These application points may be part of the junction between the nozzle plate and the printhead body, so that capillary propagation may start immediately. An advantage of requiring only one or a few application points is that places or areas around the junction that are difficult to access because of physiscal or manufacturing constraints, become accessible for application of an adhesive bond. The application points for the adhesive may be accessed from the back side of the nozzle plate (see FIG. 5A), i.e. via the interior of the printhead, if these points are still accessible at that stage of printhead manufacturing, or they may be accessed from the front side of the nozzle plate, i.e. via the exterior of the printhead, through punctures in the nozzle plate (see FIG. 5B). The punctures in the nozzle plate are automatically sealed when dispensing of the adhesive stops and the syringe or needle used to dispense the adhesive is withdrawn. The advantage of being able to bond an interior junction in the printhead from the exterior side of the printhead makes the invention also advantageously applicable in nozzle plate repair processes or in nozzle plate replacements processes. Whenever a printhead shows an ink or air leak at the interface between the nozzle plate and the ink chamber, this defect can be fixed easily by providing an extra amount of adhesive at those locations. The extra amount of adhesive may be injected through the nozzle plate with syringe. The adhesive is then capillary transported around, behind the nozzle plate and into the voids between the nozzle plate and the front end of the printhead body, repairing the leaks. Because of the capillary properties of the adhesive, transport of the adhesive into a void automatically stops at the boundary of the void with the inside of the ink chamber, because that is the end of the capillary, thereby avoiding entrance of adhesive into the ink chambers. When pulling back the syringe the aperture from the needle is sealed automatically with the adhesive. Because ink leakage tests can only be performed in one of the latest stages in the printhead manufacturing process or even during first print tests, a fix of a nozzle plate bonding failure can increase the economical yield of the printhead manufacturing process significantly. In FIGS. 5A and 5B, application of the adhesive for capillary bonding is represented by use of a syringe, but any other suitable application tool, including fully automated dispensing equipment, may be used.

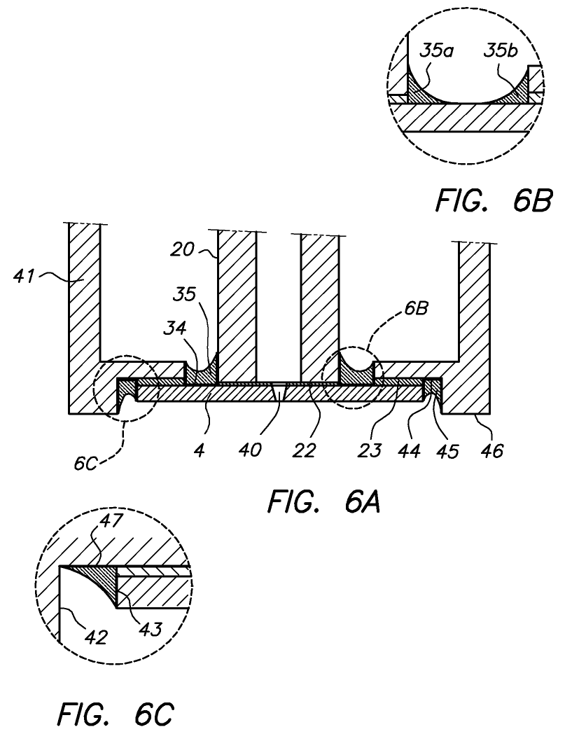

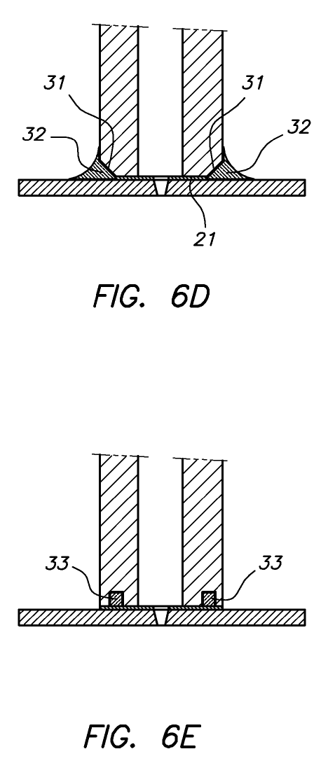

The junction between the nozzle plate and the front surface of the printhead body where the adhesive for capillary bonding is applied may have different configurations or shapes. FIGS. 6A, 6D and 6E illustrate different embodiments. In FIG. 6A an additional nozzle plate support component 41 is added to the printhead body assembly 20. The nozzle plate support 41 carries the marginal part of the nozzle plate 4 and may extend inward to increase the supported marginal area of the nozzle plate 4. The nozzle plate 4 may be affixed to the nozzle plate support 41 in different ways. The nozzle plate 4 may be bond to the nozzle plate support 41 via a thin adhesive layer applied in a similar way, and possibly in the same manufacturing stage, as the hydraulic bond between the nozzle plate 4 and printhead body 20. The nozzle plate 4 may also be bond to the nozzle plate support 41 using dispensed adhesive beads on the nozzle plate support 41 that, during affixing of the nozzle plate 4 onto the nozzle plate support 41, spread to form an adhesive layer 23 at the interface. An excess of adhesive material dispensed on the nozzle plate support 41 and squeezed out during fixing of the nozzle plate 4 onto the nozzle plate support 41, may evacuate towards an edge of the nozzle plate 4 or an edge of the nozzle plate support 41, without being a danger to the ink ejection process in the ink chambers 3. If the nozzle plate support 41 extends inward almost up to the printhead body 20, a gutter 34 is created between an edge of the nozzle plate support and an edge of the printhead body. If adhesive is applied in this gutter 34, a capillary bond 35 with a “U” shaped meniscus is created. If the nozzle plate support 41 does not extend far enough inward to approach the printhead body 20 close enough, after capillary flow and curing of the adhesive a situation as illustrated in the detail on FIG. 6B may be created with two adhesive joints 35a and 35b. The same holds for the gutter 44 in the area between an edge 43 of the nozzle plate 4 and an edge 42 of the raised outer border 46 of the nozzle plate support 41. The raised outer border of the nozzle plate support provides mechanical protection of the nozzle plate, i.e. the nozzle plate has a submerged position with regard to the outer border of the nozzle plate support and possibly also with respect ot the outer space envelop of the printhead. Because peeling of the nozzle plate during wiping action with a wiper blade may also be initiated at an edge of the nozzle plate 4, it may be advantageous to strengthen the bond at the edge of the nozzle plate by providing a capillary bond 45 at the junction between the edge 43 of the nozzle plate 4 and the support surface 47 of the nozzle plate support 41.

In FIG. 6D the outer edge of the front surface 21 of the printhead body 20 is beveled. The beveled edge 31 creates an undercut 32 in the junction and a larger contact surface for the adhesive bond. The adhesive will flow into the undercut 32 and finally establish a mechanically stronger bond.

In FIG. 6E dedicated capillaries are designed as tracks 33 into the interface surface between the nozzle plate 4 and the front surface 21 of the printhead body 20. The tracks enable capillary distribution of adhesive along these tracks and past places that otherwise would not be available for creating a capillary bond. The capillary tracks 33 may be designed into the front surface of the printhead body, as illustrated in FIG. 6E, but may also be designed into the back surface of the nozzle plate. Being able to use a larger capillary bond area between the nozzle plate and the printhead body, than only the exterior junction at the interface between the two, allows a printhead designer/manufacturer to make the nozzle plate to printhead body bond stronger. The capillary tracks also allow the creation of location specific bond properties, e.g. track density differences, different type of adhesive for dedicated tracks, etc. For the purpose of application of the adhesive it is advantageous to provide an open end of the capillary track on the junction between the nozzle plate and the printhead body, so that adhesive can be dispensed at a location on the junction and capillary transported into the tracks. This is however not a necessity because also the puncture method through the nozzle plate can be used to inject adhesive right into the tracks.

Experiments have been conducted to quantify the advantageous effects of the invention, e.g. the increase in peel strength of a nozzle plate affixed to a printhead body using the methods of the invention. In the experiments a polyimide nozzle plate was used and affixed to a piezoelectric ceramic printhead body. An hydraulic bond between the nozzle plate and the front surface of the printhead body was realized with Epotek 301-2FL using the dipping method as described before, resulting in an hydraulic bond thickness of 5 micrometers. The adhesive used was Epotek U300 and the junction between the nozzle plate and the printhead body had a straight angle, i.e. a situation as depicted in FIG. 3. Both adhesives were cured at 80° C. for 2 hours. Three forces related to the peel resistance of the nozzle plate to printhead body bond, at a force angle of 45°, were measured. The experiments show that the peeling process is actually an intermittent process that every time again requires a peeling force to overcome the bond strength after which the requires peeling force to sustain the process reduces until it stops and has to be started again by increasing the peeling force until the bond breaks again, etc. The peeling forces measured in the experiments are the initial force required to start the peeling process and which is related to the breaking of the capillary bond at the junction of the nozzle plate and the printhead body, indicated in FIG. 8 as “delamination start peak”, and the minimum and maximum peeling forces required to continue the intermittent peeling process as described above, indicated as “min. peeling force” and “max. peeling force”. The minimum and maximum peeling force to sustain the peeling process are related to the breaking of the hydraulic bond between the nozzle plate and the front surface of the printhead body. The results show that the delamination start peak increases with a factor ×10 when a capillary bond is present at the junction of the nozzle plate with the printhead body. The minimum and maximum peeling forces, to sustain the peeling process, are less affected by an additional capillary bond. The reason is clearly that the capillary bond is the first bond that needs to be broken to start the delamination or peeling process. Once the capillary bond is broken, the forces to further peel off the nozzle plate are significantly lower than the delamination start peak. The experiments also show that, that part of the junction between the nozzle plate and the printhead body that is perpendicular to the direction of the peeling force is determining the delamination start peak. That is, the longer the junction perpendicular to the peeling force, the stronger the bond that needs to be broken at once to start the delamination process.

The invention therefore enables printhead and printer designers to optimize and match their designs, in a way that the direction of wiping with a wiper blade is made perpendicular to a junction of the nozzle plate with the printhead body or the nozzle plate support, and vice versa. More specifically, if the direction of wiping and the position of the wiper blade during wiping in an inkjet printer is known, which is often printheads may be designed or mounted into the printer such that they incorporate a major capillary joint, between their nozzle plate and the printhead body or nozzle plate support, that is substantially parallel with the wiper blade. A matched design will increase the printhead's lifetime as well, because it will be less vulnerable to mechanical impact of wipers onto its nozzle plate. The invention therefore also includes an inkjet printer incorporating an inkjet printhead manufactured with the bonding techniques described above and preferably having an orientation and movement of the wiper blade such that peel forces of the wiper blade onto the nozzle plate, during wiping, are absorbed by capillary bonds of the nozzle plate.

So far, the invention has been illustrated with one nozzle plate being affixed to one printhead body. The invention however is not limited to this type of embodiments. In FIG. 4 and example is shown of two printhead bodies each comprising a set of ink chambers, affixed to one nozzle plate. A practical example may be two 180 dpi printhead bodies, i.e. having an array of ink chambers at a pitch of 180 chambers per inch, being positioned such that the front ends of the ink chambers of both printhead bodies are interlaced in a direction perpendicular to the direction of the arrays themselves, and affixed to a single nozzle plate to create a single printhead with a nozzle pitch of 360 dpi or 360 ink ejection location per inch.

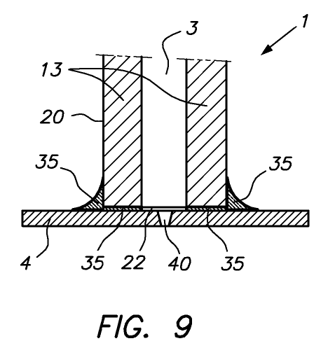

The results obtained with a capillary bond are, from a mechanical point of view, so advantageous that it provides an opportunity to only rely on the capillary bond to affix a nozzle plate to a printhead body and leave out the hydraulic sealing bond. The hydraulic sealing bond had two major targets. One is to position the nozzle plate versus the open ends of the ink chambers and maintaining this position until the capillary bond provides a firm fixing of that position. The other is to hydraulically seal the ink chamber to the nozzle plate. The first target may be realized also by using a tool that positions the nozzle plate in flat condition in front of the printhead body and holds the nozzle plate during the capillary bonding process, e.g. a stamp tool having a plurality of vacuum holes to hold a nozzle plate can serve this purpose. The second target is intrinsically met when the adhesive is applied, because the adhesive, like an underfill glue, will flow into the capillary between the back of the nozzle plate and the front surface of the printhead body, when these parts are positioned in close proximity to each other, e.g. closer than 10 micrometers from each other, preferably closer than 5 micrometers. In FIG. 9 it is illustrated how the adhesive flows in the interface between nozzle plate and front side of the printhead body, until it reaches the interior of the ink chambers, where the capillary stops. So the nozzle plate affixing process can be simplified, from a manufacturing point of view, by applying only a capillary bonding step at a time when the nozzle plate and printhead body are rigidly positioned in close proximity to each other en kept that way during curing of the adhesive. Eliminating the hydraulic sealing step not only eliminates an adhesive application step but also an adhesive curing step. A disadvantage may be that, depending on the type of inkjet ink used, a compromise may have to be made as to the chemical resistance of the adhesive to the ink chemistry versus its capillary flow and bond strength properties.

Having described in detail preferred embodiments of the current invention, it will now be apparent to those skilled in the art that numerous modifications can be made therein without departing from the scope of the invention as defined in the appending claims.

Numerals used in the drawings:
1 Printhead
3 Ink chamber
4 Nozzle plate
5 Ink chamber wall
13 Top, bottom or side walls of an ink chamber
20 Printhead body
21 Front surface of the printhead body
22, 23 Hydraulic bond
31 Beveled edge
32 Undercut
33 Capillary track
34 Gutter between printhead body and inner border of the nozzle plate support
35 35a, 35b Capillary bond
40 Nozzle
41 Nozzle plate support
42 Edge of the raised outer border of the nozzle plate support
43 Edge of the nozzle plate
44 Gutter between nozzle plate edge and raised border of the nozzle plate support
45 Capillary bond
46 Raised outer border of the nozzle plate support
47 Support surface of the nozzle plate support
α Bond angle

1. A method of affixing a nozzle plate to an inkjet printhead body, comprising the steps of:
providing an ink chamber in the printhead body, the ink chamber having an open end at a front surface of the printhead body;
providing a nozzle plate comprising a nozzle;
applying a first adhesive to the front surface of the printhead body or to a back of the nozzle plate;
positioning the nozzle plate with respect to the open end of the ink chamber in the front surface of the printhead body and affixing the nozzle plate to the front surface of the printhead body;
applying a second adhesive at one or more locations along a junction between the nozzle plate and the front surface of the printhead body;
wherein the second adhesive creates a capillary bond between the nozzle plate and the front surface of the printhead body by capillary propagation of a meniscus of the second adhesive along the junction.

2. The method according to claim 1, further providing a capillary track in the front surface of the printhead body or the back of the nozzle plate, such that during the step of applying the second adhesive, the second adhesive creates a capillary bond by capillary propagation of the meniscus of the second adhesive along the capillary tracks.

3. The method according to claim 1, further comprising holding at least one component from the list of the second adhesive, the nozzle plate or the printhead body at an elevated temperature to adjust an adhesive bonding property.

4. The method according to claim 1, further comprising applying the second adhesive via a puncture through the nozzle plate.

5. A method of affixing a nozzle plate to an inkjet printhead body, comprising the steps of:
providing an ink chamber in the printhead body, the ink chamber having an open end at a front surface of the printhead body;
providing a nozzle plate comprising a nozzle;
positioning the nozzle plate and the open end of the ink chamber in the front surface of the printhead body in close proximity to each other, thereby creating a capillary interface between the nozzle plate and the front surface of the printhead body;
applying an adhesive at one or more locations at the interface between the nozzle plate and the front surface of the printhead body;
wherein the second adhesive creates a capillary bond between the nozzle plate and the front surface of the printhead body by capillary propagation of the adhesive in the interface between the nozzle plate and the front surface of the printhead body.

6. The method according to claim 5 wherein the nozzle plate and the front surface of the printhead body are positioned closer than about 10 micrometers from each other.

7. The method according to claim 6, further including holding at least one component from the list of the adhesive, the nozzle plate or the printhead body at an elevated temperature to adjust an adhesive bonding property.

8. An inkjet printhead comprising:
an inkjet printhead body including an ink chamber having an open end at a front surface of the printhead body;
a nozzle plate having a nozzle;
a first adhesive layer at an interface between the front surface of the printhead body and a back of the nozzle plate; and
a second adhesive at one or more locations along a junction between the front surface of the printhead body and the nozzle plate;
wherein the second adhesive constitutes a capillary bond at the junction between the front surface of the printhead body and the nozzle plate through capillary propagation of a meniscus of the second adhesive along the junction.

9. An inkjet printhead according to claim 8, further comprising a capillary track in the front surface of the printhead body or the back of the nozzle plate, such that the second adhesive extends into the capillary tracks by capillary forces.

10. An inkjet printhead according to claim 8, further comprising a nozzle plate support supporting a marginal area of the nozzle plate and wherein a junction between the nozzle plate and the nozzle plate support component comprises a capillary bond.

11. An inkjet printer including an inkjet printhead comprising:
an inkjet printhead body including an ink chamber having an open end at a front surface of the printhead body;
a nozzle plate having a nozzle;
a first adhesive layer at an interface between the front surface of the printhead body and a back of the nozzle plate; and
a second adhesive at one or more locations along a junction between the front surface of the printhead body and the nozzle plate;
wherein the second adhesive constitutes a capillary bond at the junction between the front surface of the printhead body and the nozzle plate through capillary propagation of a meniscus of the second adhesive along the junction.

12. An inkjet printer according to claim 11 further comprising:
a printhead maintenance module having a wiper blade, the wiper blade having a fixed angular position with respect to the nozzle plate; and
means for moving the wiper blade along the nozzle plate;
wherein a part of the junction comprising the capillary bond is substantially parallel with a fixed angular position of the wiper blade.

13. A method of affixing a nozzle plate to an inkjet printhead body, comprising the steps of:
providing an ink chamber in the printhead body, the ink chamber having an open end at a front surface of the printhead body;
providing a nozzle plate comprising a nozzle;
providing a nozzle plate support component for supporting a marginal area of the nozzle plate;
applying a first adhesive to the front surface of to the printhead body or a back of the nozzle plate;
positioning the nozzle plate with respect to the open end of the ink chamber in the front surface of the printhead body and affixing the nozzle plate to the front surface of the printhead body;
applying a second adhesive at one or more locations along a first junction between the nozzle plate and the front surface of the printhead body and at one or more locations along a second junction between the nozzle plate and a support surface of the nozzle plate support component;
wherein the method further includes:
creating a capillary bond between the nozzle plate and the printhead body by capillary propagation of a meniscus of the second adhesive along the first junction; and
creating a capillary bond at a junction between the nozzle plate and the nozzle plate support component by capillary propagation of a meniscus of the second adhesive along the second junction.
